(19) United States
(12) Patent Application Publication
(10) Pub. No.: US 2014/0005315 A1
(43) Pub. Date: Jan. 2, 2014

(54) Branched Polyalkylene Glycol Ethers As De-Airing Wetting And Dispersing Agents For Aqueous Dispersion Colors

(71) Applicants: Hendrik Ahrens, Kriftel (DE); Carsten Schaefer, Muehldorf (DE)

(72) Inventors: Hendrik Ahrens, Kriftel (DE); Carsten Schaefer, Muehldorf (DE)

(73) Assignee: CLARIANT FINANCE (BVI) LIMITED, Tortola (VG)

(21) Appl. No.: 14/004,985

(22) PCT Filed: Mar. 8, 2012
(86) PCT No.: PCT/EP2012/001026

§ 371 Date: Sep. 13, 2013

(30) Foreign Application Priority Data
Mar. 16, 2011 (DE) 10 2011 014 048.4

(51) Int. Cl. C08K 13/02

(52) U.S. Cl. CPC C08K 13/02
USPC 524/244; 524/376

(57) ABSTRACT

The invention relates to dispersion colors, containing water and (A) at least one polymer dispersion comprising homopolymers and copolymers from olefinic unsaturated monomers; (B) at least one inorganic white pigment or an inorganic filler material; (C) at least one organic colored pigment or rust pigment; (D) at least one composition of formula (I), where A is a residue derived from a polyhydric alcohol or alkanolamine having at least three active hydrogen atoms; R is a methyl or ethyl residue; R′ is a hydrogen atom or a methyl, ethyl, propyl or butyl residue; n is an integer from 1 to 250; m is an integer from 1 to 500; x is smaller than or equal to the number of hydrogen atoms in the polyhydric alcohol or alkanolamine from which A is derived, and where the polyoxyethylene and polyoxyalkylene groups are arranged in blocks corresponding to the sequence specified in formula (I).

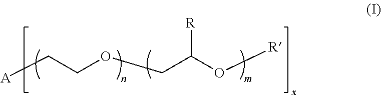

The present invention relates to aqueous emulsion paints which comprise branched polyalkylene glycol ethers as deaerating wetting agent and dispersant, and also to the use of the branched polyalkylene glycol ethers as deaerating wetting agent and dispersant for aqueous emulsion paints.

Aqueous emulsion paints comprise polymer dispersions, also called binder, latex, or polymer emulsions, inorganic white pigments, and fillers, and also auxiliaries such as wetting agents and dispersants, rheological additives, defoamers, preservatives, fungicides, algicides, film-forming assistants, solvents, and buffer substances. During the tinting of aqueous emulsion paints, pigment preparations are metered in volumetrically or gravimetrically and are dispersed homogeneously in the emulsion paint. This dispersion may take place by hand, by means of stirring, or using an electric stirrer, or in a paint mixing apparatus, a shaker machine, for example, or on a shaking platform, also called ink shaker or paint shaker.

Tinting with pigment preparations comprising organic pigments or carbon black pigments is often accompanied by streakiness and an inconsistent color outcome as a result of differences in shade. The organic pigments flocculate in the paint and during the drying process, and so the color strength is reduced. In the course of brushing or rolling, the pigment agglomerates are separated again, but to differing extents, and so the observed shade differences occur. In the laboratory, this phenomenon is simulated in a rubout test. The rubout test is described in the specification U.S. Pat. No. 3,840,383.

In order to avoid the differences in shade, and rubout, suitable wetting agents are added to the emulsion paints.

US-2006/207476 describes latex-compatible surfactants selected from the group of nonylphenol ether phosphoric esters, nonylphenol ethoxylates, alkylpolyethylene glycol ethers, dinonylsulfosuccinate, difunctional propylene oxide/ethylene oxide block polymers (with secondary OH groups), secondary alcohol ethoxylates, and, among others, hydrogenated castor oil ethoxylate with 40 mol of ethylene oxide, and dispersants for universal color pastes, which can be employed as tinting pastes not only for aqueous emulsion paints but also for solventborne alkyd paints.

US-2008/110368 describes a paint formulation comprising a pigment powder and nonionic surfactants selected from the group of acetylene surfactants, alkylphenol ethoxylates, ethylene oxide/propylene oxide block copolymers, alcohol ethoxylates, and mixtures thereof.

Although in accordance with the prior art a multiplicity of compounds are proposed as suitable wetting agent and dispersant, there are in practice continually problems with rubout after the tinting of emulsion paints with organic pigment preparations.

Alkoxylates have already been described in the literature for a multiplicity of applications and in different chemical compositions. The majority of the alkoxylates described are linear alcohol alkoxylates or linear ethylene oxide/propylene oxide block copolymers.

DE-A-10332527 describes the use of polyalkylene oxides for avoiding bodying of aqueous polymer dispersions stabilized with protective colloids.

EP-A-0115926 describes the use of water-soluble polyoxypropylene/polyoxyethylene/polyoxypropylene block copolymers in aqueous cooling lubricants for metalworking.

EP-A-1167452 describes the use of block-copolymeric phosphoric esters and salts thereof as pigment wetting agents for pigment pastes, aqueous, solventborne, low-solvent, and solvent-free paints and printing inks. The block-copolymeric phosphoric esters are prepared by blockwise reaction of alkylol with styrene oxide, ethylene oxide, and optionally with further alkylene oxides, and then reacted to give the phosphoric ester.

EP-A-1771520 describes alcohol alkoxylates for use as low-foam wetting agents for coating materials comprising binders, pigments, fillers, additives, and solvents.

U.S. Pat. No. 3,945,964 describes alcohol alkoxylates for use as dispersants for aqueous epoxy resin dispersions.

U.S. Pat. No. 4,091,164 describes ethylene oxide/propylene oxide block copolymers for use as dispersants for inorganic pigments and fillers in thermoplastics.

U.S. Pat. No. 5,114,607 describes ethylene oxide/propylene oxide block copolymers for use as low-foaming surfactants in liquid metal-cleaning products.

U.S. Pat. No. 5,500,219 describes ethylene oxide/propylene oxide block copolymers for use as dispersants for water-dispersible pesticide granules.

U.S. Pat. No. 6,083,998 describes ethylene oxide/propylene oxide block copolymers for use as a defoamer component for fermentation procedures.

US-A-2003/144397 describes alcohol alkoxylates for use as emulsifiers for aqueous alkyd resin paints.

US-A-2004/254295 describes alcohol alkoxylates for use as emulsifiers for emulsion polymers.

US-A-2005/288389 describes ethylene oxide/propylene oxide block copolymers for use as wetting agents for hydrophobic soiling.

WO-02/16471 describes alcohol alkoxylates as dispersants for organic pigment in solventborne paints.

Additionally, branched alkoxylates and graft polymers with ethylene oxide/propylene oxide side chains are described in the literature for use as wetting agents and dispersants.

EP-A-1643833 describes alkanol alkoxylates for use as penetration promoters and also an ethylenediamine alkoxylate derivative for use as an emulsion stabilizer or crystallization inhibitor in crop protection formulations.

EP-A-1650246 describes alkoxylated epoxide-amine adducts having a number-average molecular weight of more than 500 g/mol and preparable by the reaction of mono- and polyepoxides, primary or secondary amines and alkanolamines, and alkylene oxides for use as wetting agents and dispersants for organic and inorganic pigments and fillers in pigment preparations. The same specification also describes basic polyalkylene oxides based on alkoxylated ethylenediamine for use as prior-art wetting agents and dispersants.

U.S. Pat. No. 4,540,442 describes ethylenediamine-ethylene oxide/propylene oxide block copolymer for use as a cleaning component for aqueous paint strippers.

U.S. Pat. No. 5,629,260 describes the use of branched ethylene oxide/propylene oxide block copolymers for use as wetting agents for aqueous herbicide solutions.

U.S. Pat. No. 6,028,046 describes alkoxylated polyimines for use as antiredeposition agents for fabric detergents.

U.S. Pat. No. 6,300,304 describes alkoxylated polyimines for use as soil release polymers in laundry detergents.

US-A-2007/299228 describes branched ethylene oxide/propylene oxide block copolymers for use as emulsifiers for aqueous alkyd resin dispersion and aqueous alkyd resin paints.

WO-2009/130282 describes the use of alcohol alkoxylates and branched ethylene oxide/propylene oxide block copolymers as dispersants for aqueous pesticide suspensions.

In accordance with the prior art, ethylenediamine-ethylene oxide/propylene oxide block copolymers in particular are recommended as wetting agents for emulsion paints. An ethylenediamine-ethylene oxide/propylene oxide block copolymer having a cloud point of 27-30° C., measured with 5 g in 25 cm³ of 25% aqueous butyl diglycol solution, is recommended as a wetting agent and color strength enhancer for organic pigments and carbon blacks for aqueous coating materials.

Disadvantageous features of the ethylenediamine-ethylene oxide/propylene oxide block copolymers are the dark color and the ammoniacal odor.

It has now been found that the compounds of the formula (I) boost the color strength of emulsion paints tinted with organic chromatic pigments and carbon black pigments, and prevent rubout. The compounds of the formula (I) improve the wetting capacity of the emulsion paint without affecting the rheological properties of the emulsion paint, and during the preparation of the paint they exert a defoaming action and effect deaeration.

It was an object of the present invention, therefore, to find suitable compounds which are added to the emulsion paints in order to avoid the described rubout problems and which do not exhibit any adverse secondary effects.

Surprisingly it has been found that branched alkoxylates of the formula (I) satisfy this object.

The invention accordingly provides emulsion paints comprising water and
(A) at least one polymer dispersion which comprises homopolymers or copolymers of olefinically unsaturated monomers,
(B) at least one inorganic white pigment or one inorganic filler,
(C) at least one organic chromatic pigment or carbon black pigment,
(D) at least one compound of the formula (I)

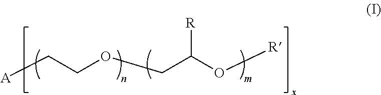

in which
A is a radical derived from a polyfunctional alcohol or alkanolamine having at least 3 active hydrogen atoms,
R is a methyl or ethyl radical,
R′ is a hydrogen atom or a methyl, ethyl, propyl, or butyl radical,
n is an integer from 1 to 250, preferably from 5 to 100, and more preferably from 10 to 50,
m is an integer from 1 to 500, preferably from 10 to 200, and more preferably from 20 to 100,
x is less than or equal to the number of active hydrogen atoms in the polyfunctional alcohol or alkanolamine from which A is derived,
   and in which the polyoxyethylene and the polyoxyalkylene groups are arranged blockwise in the order indicated in the formula (I).

The invention further provides for the use of compounds of the formula (I) as a deaerating wetting agent and dispersant in the abovementioned emulsion paints.

Additionally provided by the invention is a method for deaerating the abovementioned emulsion paints by adding at least one compound of the formula (I) to the emulsion paints.

For the purposes of this invention the rubout is determined in accordance with the test described in U.S. Pat. No. 3,840,383.

In one preferred embodiment the emulsion paints of the invention further comprise
(E) customary auxiliaries used for emulsion paints and selected from the group consisting of wetting agents, dispersants, defoamers, rheological additives, biocides, fungicides, algicides, film-forming assistants, buffer substances such as aqueous sodium hydroxide solution, ammonia solution, amines such as 2-amino-2-methyl-1-propanol, and acids such as sulfuric acid, hydrochloric acid, and acetic acid.

In another preferred embodiment the emulsion paints of the invention further comprise
(F) further adjuvants selected from the group consisting of inorganic chromatic pigments, silicone resins, potassium silicate, or alkyd resin dispersions.

Suitability as component (A) is possessed by polymer dispersions based on unsaturated monomers. Preferred olefinically unsaturated monomers are for example
vinyl monomers, such as carboxylic esters of vinyl alcohol, as for example vinyl acetate, vinyl propionate, and vinyl ethers of isononanoic acid or of isodecanoic acid,
aryl-substituted olefins, such as styrene and stilbene,
olefinically unsaturated carboxylic esters, such as methyl acrylate, ethyl acrylate, propyl acrylate, n-butyl acrylate, isobutyl acrylate, pentyl acrylate, hexyl acrylate, 2-ethylhexyl acrylate, hydroxyethyl acrylate, and also the corresponding methacrylic esters,
olefinically unsaturated dicarboxylic esters, such as dimethyl maleate, diethyl maleate, dipropyl maleate, dibutyl maleate, dipentyl maleate, dihexyl maleate, and di-2-ethylhexyl maleate,
olefinically unsaturated carboxylic acids and dicarboxylic acids, such as acrylic acid, methacrylic acid, itaconic acid, maleic acid, and fumaric acid, and their sodium, potassium, and ammonium salts,
olefinically unsaturated sulfonic acids and phosphonic acids and their alkali metal and ammonium salts, such as acrylamidomethylpropanesulfonic acid and its alkali metal and ammonium salts, alkylammonium and hydroxyalkylammonium salts, and allylsulfonic acid and its alkali metal and ammonium salts, acryloyloxyethylphosphonic acid and its ammonium and alkali metal salts, and also the corresponding methacrylic acid derivatives,
olefinically unsaturated amines, ammonium salts, nitriles and amides, such as dimethylaminoethyl acrylate, acryloyloxyethyltrimethylammonium halides, acrylonitrile, N-methylacrylamide, N-ethylacrylamide, N-propylacrylamide, N-methylolacrylamide, and also the corresponding methacrylic acid derivatives, and vinylmethylacetamide.

In one preferred embodiment the abovementioned monomers for preparing the polymer dispersions are polymerized with further comonomers, preferably olefins or halogenated olefins having 2 to 8 carbon atoms, such as ethylene, propene, butene, pentene, 1,3-butadiene, chloroprene, vinyl chloride, vinylidene chloride, vinylidene fluoride, and tetrafluoroethylene, for example.

Suitability as component (B) is possessed by inorganic white pigments and fillers such as, for example, titanium dioxides, calcium carbonates, talc, kaolin, barium sulfates, zinc sulfides, and zinc oxides. Preference is also given to using mixtures of the stated inorganic white pigments. One particularly preferred mixture of inorganic white pigments comprises titanium dioxide, calcium carbonate, talc, and kaolin.

Contemplated as component (C) are monoazo, disazo, laked azo, β-naphthol, naphthol AS, benzimidazolone, disazocondensation, azo metal complex pigments, and polycyclic pigments, such as phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline, and diketopyrrolopyrrole pigments, for example, or carbon blacks.

An exemplary selection of particularly preferred organic chromatic pigments includes carbon black pigments, such as gas blacks or furnace blacks, for example; monoazo and disazo pigments, more particularly the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Yellow 219, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34, or Pigment Brown 41; β-naphthol and naphthol AS pigments, more particularly the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38, or Pigment Brown 1; laked azo and metal complex pigments, more particularly the Colour Index pigments Pigment Red 48:2, Pigment Red 48:3, Pigment Red 48:4, Pigment Red 57:1, Pigment Red 257, Pigment Orange 68, or Pigment Orange 70; benzimidazoline pigments, more particularly the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72, or Pigment Brown 25; isoindolinone and isoindoline pigments, more particularly the Colour Index pigments Pigment Yellow 139 or Pigment Yellow 173; phthalocyanine pigments, more particularly the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7, or Pigment Green 36; anthanthrone, anthraquinone, quinacridone, dioxazine, indanthrone, perylene, perinone, and thioindigo pigments, more particularly the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23, or Pigment Orange 43; triarylcarbonium pigments, more particularly the Colour Index pigments Pigment Red 169, Pigment Blue 56, or Pigment Blue 61; diketopyrrolopyrrole pigments, more particularly the Colour Index pigments Pigment Red 254, Pigment Red 255, Pigment Red 264, Pigment Red 270, Pigment Red 272, Pigment Orange 71, Pigment Orange 73, or Pigment Orange 81.

Component (D) comprises a branched alkoxylation product of polyfunctional alcohols or alkanolamines. A in formula (I) is a radical derived from a polyfunctional alcohol or an alkanolamine. The term “derived” means the formal abstraction of the hydrogen atoms amendable to alkoxylation. Preferred polyfunctional alcohols from which A derives are glycerol, butanetriol, hexanetriol, trimethylolpropane, pentaerythritol, xylitol, sugar alcohols (alditols) such as, for example, mannitol, isomalt, lactitol, sorbitol, glucitol, xylitol, threitol, and erythritol. Generally speaking, polyfunctional alcohols have as many hydrogen atoms amendable to alkoxylation as they comprise OH groups.

In another preferred embodiment of the invention, A is derived from alkanolamines such as ethanolamine, diethanolamine, and triethanolamine. Generally speaking, alkanolamines have as many hydrogen atoms amenable to alkoxylation as they comprise OH groups and NH groups, and twice as many hydrogen atoms amenable to alkoxylation as they comprise NH₂ groups. The hydrogen atoms capable of alkoxylation are also referred to here as active hydrogen atoms.

A comprises preferably up to 8 active hydrogen atoms, more particular 4 to 6 active hydrogen atoms. x is preferably equal to the number of active hydrogen atoms in A. In another preferred embodiment, x is 3, 4, 5, or 6.

The components (E) are customary auxiliaries used for emulsion paints, such as wetting agents, dispersants, defoamers, rheological additives, biocides, fungicides, algicides, buffer substances such as aqueous sodium hydroxide solution, ammonia solution, amines such as 2-amino-2-methyl-1-propanol, and acids such as sulfuric acid, hydrochloric acid, and acetic acid.

Suitable wetting agents and dispersants are nonionic surfactants from the class of the alkylpolyethylene glycol ethers, fatty acid ethoxylates, alkylpolyglycosides, sorbitan ester ethoxylates, alkynediol ethoxylates, ethylene oxide and propylene oxide block copolymers, and adducts of ethylene oxid and propylene oxide with alcohols, and alkylphenol ethoxylates and alcohol ethoxylates with methyl, butyl, and benzyl endgroup capping. Use is also made, for example, of wetting agents and dispersants from the class of the anionic surfactants from the group of the sodium, potassium, and ammonium salts of fatty acids, sodium alkylbenzenesulfonates, sodium alkylsulfonates, sodium olefinsulfonates, sodium polynaphthalenesulfonates, sodium dialkyl diphenyl ether disulfonates, sodium, potassium, and ammonium alkylsulfates, sodium, potassium, and ammonium alkylpolyethylene glycol ether sulfates, sodium, potassium, and ammonium alkylphenol polyethylene glycol ether sulfates, sodium, potassium, and ammonium mono- and dialkylsulfosuccinates and monoalkylpolyoxyethylsulfosuccinates, and also alkylpolyethylene glycol ether phosphoric monoesters, diesters, and triesters, and mixtures thereof, and alkylphenolpolyethylene glycol ether phosphoric monoesters, diesters, and triesters and mixtures thereof, and also the sodium, potassium, and ammonium salts thereof.

Dispersants used for inorganic pigments and fillers are homopolymers and copolymers of acrylic acid, methacrylic acid, maleic acid, fumaric acid, and acrylic and methacrylic esters and the sodium, potassium, and ammonium salts thereof.

Suitable defoamers are mineral oil defoamers, silicone defoamers, or defoamers based on polyalkylene glycol ethers. Defoaming components of the stated defoamer classes are hydrophobic particulate solids such as hydrophobically modified silica, fatty acid salts of divalent and trivalent cations such as aluminum stearate and calcium stearate, amide waxes such as ethylenebisstearylamide, and silicone resins.

Customary rheological additives are bentonites, silica, cellulose ethers, hydrophobically modified urethanes, and alkali-soluble acrylate thickeners.

The emulsion paints of the invention typically comprise preservatives to prevent infestation by microorganisms. Customary preservatives are formaldehyde and formaldehyde donor compounds such as dihydroxy-2,5-dioxahexane, chloromethylisothiazolinone, benzylisothiazolinone, benzimidazolinone, and bronopol. To prevent infestation by fungi and algae, particularly following application of the emulsion paints to exterior walls, facades, shingles, and metallic and plastics parts such as gutters in the exterior sector, film preservatives may be added to the emulsion paints. Suitable examples include diuron, carbendazim, octylisothiazolinone, dichlorooctylisothiazolinone, zinc pyrithione, terbutryn, and lrgarol as film preservatives.

Employed as film-forming assistants are substances which lower the minimum film formation temperature to down to below 5° C., such as, for example, white spirit, methylpropylene glycol, methyldipropylene glycol, methyltripropylene glycol, butyl glycol, butyl diglycol, butyldipropylene glycol, and butyltripropylene glycol, diethylene glycol benzoate, trimethylpentane-1,3-diol monoisobutyrate, isodecylbenzoate, isononylbenzoate, monoethylene glycol, and monopropylene glycol monooleate, and lactic esters of alcohols having 6 to 30 carbon atoms.

Used as buffer substances for the emulsion paints of the invention are acids and alkalis such as aqueous sodium hydroxide solution, ammonia solution, amines such as 2-amino-2-methyl-1-propanol, triethanolamine, dimethylaminoethanol, and acids such as sulfuric acid, hydrochloric acid, acetic acid, and formic acid.

The emulsion paint of the invention may optionally be admixed with further components (F). Emulsion paints may optionally also be admixed with inorganic chromatic pigments, in order to produce a desired shade using a mixture of organic and inorganic pigments.

Suitable inorganic chromatic pigments are iron oxides, magnetites, manganese iron oxides, chromium oxides, ultramarine, nickel or chromium antimony titanium oxides, manganese titanium rutiles, cobalt oxides, mixed oxides of cobalt and aluminum, rutile mixed phase pigments, rare earth sulfides, spinels of cobalt with nickel and zinc, spinels based on iron and chromium with copper, zinc, and also manganese, bismuth vanadate, and also extender pigments. Used more particularly are the Colour Index pigments Pigment Yellow 184, Pigment Yellow 53, Pigment Yellow 42, Pigment Brown 24, Pigment Red 101, Pigment Blue 28, Pigment Blue 36, Pigment Green 50, Pigment Green 17, Pigment Black 11, and Pigment Black 33.

Furthermore, the emulsion paints of the invention may comprise further film-forming components, such as silicone resins, potassium silicate, or alkyd resin dispersions.

The emulsion paints of the invention comprise

preferably 1 to 75 wt. % of (A), more particularly 5 to 50 wt. % of (A),
preferably 1 to 70 wt. % of (B), more particularly 2 to 50 wt. % of (B),
preferably 0.1 to 10 wt. % of (C), more particularly 0.2 to 5 wt. % of (C),
preferably 0.05 to 2 wt. % of (D), more particularly 0.1 to 0.5 wt. % of (D),
preferably 0.01 to 10 wt. % of (E), more particularly 0.1 to 2 wt. % of (E), and
preferably 1 to 70 wt. % of (F), more particularly 2 to 50 wt. % of (F).

The emulsion paints of the invention preferably comprise water in an amount of at least 20 wt. %, more particularly 20 to 80 wt. %, especially ad 100 wt. %.

### EXAMPLES

The emulsion paints of the invention are produced in a customary way, by first dispersing the white pigments and fillers and then metering in the polymer dispersion. The white emulsion paint produced is subsequently tinted to the desired shade, using one or more pigment preparations.

### Production of the White Emulsion Paints

TABLE 1
Formulation for white emulsion paints

| | | | in wt. |
|---|---|---|---|
| # | Component | Composition/property | % |
| 1 | Water | | 18.1 |
| 2 | Tylose ® MH 10000 YP2 | Cellulose ether, thickener | 0.2 |
| 3 | Mowiplus ® XW 330 | Dispersant for inorganic | 0.3 |
| | | pigments | |
| 4 | Wetting agent | See table 2 | 0.3 |
| 5 | D-Foam-R C 113 | Mineral oil defoamer | 0.2 |
| 6 | Kronos ® 2160 | Titanium dioxide, white pigment | 20.0 |
| 7 | Omyacarb ® 5 GU | Calcium carbonate, filler | 20.0 |
| 8 | Ammonia solution (25%) | Alkalification | 0.2 |
| 9 | Mowilith ® LDM 7717 | Acrylate dispersion, binder | 40.0 |
| | (about 50%) | | |
| 10 | Tafigel ® PUR 40 1:9 | Urethane thickener | 0.4 |
| | in water | | |
| 11 | Nipacide ® BIT 10 W | Benzisothiazolinone, biocide | 0.2 |
| | Total | | 100 |

First of all components 1-5 are introduced and then are processed to a pigment dispersion with components 6 and 7 by dispersing with a dissolver disk at high stirrer speeds (laboratory dissolver at 3000 rpm). Then components 8-11 are added, with slower stirring, since the binders used may be susceptible to shearing (laboratory dissolver at 500 rpm).

As wetting agents the following substances are used.

TABLE 2
Wetting agents of the inventive emulsion paints and comparative examples

| Example | Wetting agent | Product |
|---|---|---|
| 1 (C) | Alcohol ethoxylate with 7 mol of ethylene oxide | Emulsogen ® LCN 070 |
| 2 (C) | Ethylene oxide/propylene oxide block copolymer | Genapol ® PF 10 |
| | with an EO-PO-EO block structure and 10% | |
| | ethylene oxide, linear | |
| 3 (C) | Ethylene oxide/propylene oxide block copolymer | Genapol ® PF 20 |
| | with an EO-PO-EO block structure and 20% | |
| | ethylene oxide, linear | |
| 4 (C) | Ethylene oxide/propylene oxide block copolymer | Genapol ® PF 40 |
| | with an EO-PO-EO block structure and 40% | |
| | ethylene oxide, linear | |
| 5 (C) | Ethylenediamine ethylene oxide/propylene oxide | Genapol ® PN 30 |
| | block copolymer | |
| 6 (C) | Alcohol alkoxylate with 8 mol of ethylene oxide | Genapol ® EP 2584 |
| | and 4 mol of propylene oxide | |
| 7 (C) | Alcohol ethoxylate with 8 mol of ethylene oxide, | Genapol ® BE 2410 |
| | end group-capped with butyl chloride | |
| 8 | Glycerol + 24 EO + 48 PO | |
| 9 | Butanetriol + 24 EO + 48 PO | |
| 10 | Hexanetriol + 24 EO + 48 PO | |

The wetting agents of examples 8, 9, and 10 are block alkoxylates.

### Air Content of the White Emulsion Paints

The surface-active substances in the white emulsion paints, such as wetting agents and dispersants and emulsifiers of the binders used, may tend toward foaming, and this may hinder and prolong the production process. On account of the relatively high viscosity of the white emulsion paints, the foam becomes enclosed within the emulsion paint, and so is no longer able to escape. In order to prevent the buildup of foam, defoamers are used, their concentration dependent on the foam tendency of the surface-active compounds. It is therefore advantageous for the wetting agents and dispersants used to be low-foaming substances or even to have a defoaming effect. The density of the emulsion paints produced is therefore ascertained using a pyknometer from Elcometer Ltd, Manchester. The higher the density of the emulsion paint, the lower the air inclusion.

### Viscosity of the White Emulsion Paints

For adjusting the rheological properties, rheological additives are added to the emulsion paints of the invention, examples being cellulose ethers, urethane thickeners, and acrylate thickeners. There may be interaction between the rheological additives and wetting agents, more particularly with urethane thickeners, and so the viscosity may be lowered when the wetting agents are added. It is therefore advantageous if the wetting agents used do not lower the viscosity of the emulsion paint. The viscosity of the white emulsion paint is determined after one day, using a Brookfield viscometer, spindle 4, at 100 rpm. The viscosity of the white emulsion paint is not to alter significantly following addition of the wetting agents.

### Surface Tension of the White Emulsion Paints

The surface tension is measured, as a measure of the wetting action of the white emulsion paints. For this purpose, the white emulsion paint is diluted with water in a weight ratio of 1:1 and the surface tension is determined using a Lauda tensiometer, that operates in accordance with the platinum ring method of ASTM D971. The activity of the wetting agents used is manifested in a reduction in the surface tension. The lower the surface tension of the diluted white emulsion paints, the more effective the wetting action of the products used.

### Tinting of the Emulsion Paints

In order to set a particular shade, tinting pastes are added to the white emulsion paints. To test the color strength and compatibility of tinting pastes, 200 g of tinted emulsion paint, consisting of 98 wt. % white emulsion paint and 2 wt. % a blue pigment paste, are introduced into a metal can and homogenized for 60 seconds in an lnkshaker 500 from Olbrich Know How, Hemer. The blue pigment paste used has the composition below.

TABLE 3
Composition of the blue pigment paste for tinting the emulsion paints

| # | Comonent | Composition/property | in wt. % |
|---|---|---|---|
| 1 | Water | | 33.5 |
| 2 | Emulsogen ® LCN 118 | Dispersant | 6.0 |
| 3 | D-Foam-R C 741 | Silicone oil defoamer | 0.3 |
| 4 | Nipacide ® BIT 10 W | Benzisothiazolinone, biocide | 0.2 |
| 5 | Polyethylene glycol 300 | Moisture retainer | 10.0 |
| 6 | Hostaperm ® Blue B2G | Phthalocyanine pigment, | 50.0 |
| | | Colour Index PB 15:3 | |
| | Total | | 100.0 |

For determining the color strength and the compatibility of the color paste in the white emulsion paint, the tinted emulsion paints are coated out after one day on an test card, using a 120 μm doctor on a film-drawing instrument, model 509 MC from Erichsen GmbH, Hemer. After 7 minutes, the rubout test is performed on the drying paint film, in the manner described in specification U.S. Pat. No. 3,840,383. The colorimetric values of the fully dried film are ascertained after 24 hours, using a Konica—Minolta model CM 3600 spectrophotometer.

TABLE 4
Properties of the emulsion paints

| | | | | | Relative | |
|---|---|---|---|---|---|---|
| | | Paint | | Surface | color | |
| | | density | Viscosity | tension | strength | |
| Example | Experiment | [g/cm³] | [mPa · s] | [mN/m] | [%] | Rubout |
| 1 (C) | Emulsogen LCN 070 | 1.3276 | 2133 | 35.6 | 54.7 | Yes |
| 2 (C) | Genapol PF 10 | 1.3542 | 2000 | 36.6 | 100.8 | No |
| 3 (C) | Genapol PF 20 | 1.3587 | 1720 | 32.6 | 99.3 | No |
| 4 (C) | Genapol PF 40 | 1.3594 | 1780 | 30.6 | 100.9 | No |
| 5 (C) | Genapol PN 30 | 1.3635 | 2160 | 29.0 | 100.0 | No |
| 6 (C) | Genapol EP 2584 | 1.3515 | 2290 | 36.3 | 86.3 | No |
| 7 (C) | Genapol BE 2410 | 1.2870 | 1740 | 30.4 | 54.7 | Yes |
| 8 | Glycerol + 24 EO + | 1.3649 | 2140 | 29.8 | 97.5 | No |
| | 48 PO | | | | | |
| 9 | Butanetriol + 24 EO + | 1.3391 | 2000 | 29.6 | 97.0 | No |
| | 48 PO | | | | | |
| 10 | Hexanetriol + 24 EO + | 1.3447 | 2100 | 30.3 | 99.2 | No |
| | 48 PO | | | | | |
| 11 (C) | No wetting agent | 1.2987 | 1950 | 39.2 | 36.6 | Yes |

The inventive emulsion paints of examples 8 to 10 show the best results, together with example 5 (C), relative to the prior art: the wetting agent from example 1 (C) has a clear tendency to foam, resulting in a relatively low density of about 1.33 g/ml and in a relatively high level of air inclusion than for the wetting agents of examples 8 to 10. The wetting agents of examples 2 (C) and 6 (C) exhibit a lower wetting effect and a higher surface tension, of around 36 mN/m, relative to the wetting agents in examples 8 to 10. Use of the wetting agents of examples 3 (C) and 4 (C) leads to a lower viscosity in the emulsion paints than when using the wetting agents of examples 8 to 10. The wetting agent of example 5 (C) exhibits results comparable with those for the wetting agents of examples 8 to 10, but in contrast to the latter has an ammoniacal odor and a dark color, whereas the wetting agents of examples 8 to 10 are free from ammoniacal odor and show a pale to clear color. The reason for the dark color of the wetting agent in example 5 (C) is the use of ethylenediamine as a starter molecule for the alkoxylation. The wetting agents of examples 8 to 10, in contrast, are colorless to yellowish and are free of ammoniacal odor. The wetting agent in example 7 (C) is entirely unsuitable, since the color strength, similar to the case in example 1 (C), remains well behind the color strengths of examples 8 to 10.

1. An emulsion paint comprising water and
(A) at least one polymer dispersion which comprises homopolymers or copolymers of olefinically unsaturated monomers,
(B) at least one inorganic white pigment or one inorganic filler,
(C) at least one organic chromatic pigment or carbon black pigment,
(D) at least one compound of the formula (I) 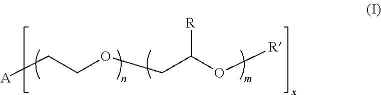
in which
A is a radical derived from a polyfunctional alcohol or alkanolamine having at least 3 active hydrogen atoms,
R is a methyl or ethyl radical,
R′ is a hydrogen atom or a methyl, ethyl, propyl, or butyl radical,
n is an integer from 1 to 250,
m is an integer from 1 to 500,
x is less than or equal to the number of active hydrogen atoms in the polyfunctional alcohol or alkanolamine from which A is derived,
and in which the polyoxyethylene and the polyoxyalkylene groups are arranged blockwise in the order indicated in the formula (I).

2. The emulsion paint as claimed in claim 1, further comprising 0.01 to 10 wt. % of (E) customary auxiliaries used for emulsion paints and selected from the group consisting of wetting agents, dispersants, defoamers, rheological additives, biocides, fungicides, algicides, film-forming assistants, buffer substances such as aqueous sodium hydroxide solution, ammonia solution, amines such as 2-amino-2-methyl-1-propanol, and acids such as sulfuric acid, hydrochloric acid, and acetic acid.

3. The emulsion paint as claimed in claim 1 and/or 2, further comprising 1 to 70 wt. % of (F) further adjuvants selected from the group consisting of inorganic chromatic pigments, silicone resins, potassium silicate, or alkyd resin dispersions.

4. The emulsion paint as claimed in one or more of claims 1 to 3, wherein the olefinically unsaturated monomers are selected from vinyl monomers, aryl-substituted olefins, olefinically unsaturated carboxylic esters, olefinically unsaturated dicarboxylic esters, olefinically unsaturated carboxylic acids and dicarboxylic acids, olefinically unsaturated sulfonic acids and phosphonic acids and alkali metal salts and ammonium salts, olefinically unsaturated amines, ammonium salts, nitriles and amides, and olefins or halogenated olefins having 2 to 8 carbon atoms.

5. The emulsion paint as claimed in one or more of claims 1 to 4, wherein A comprises up to 8 active hydrogen atoms.

6. The emulsion paint as claimed in one or more of claims 1 to 5, wherein x is 3, 4, 5, or 6.

7. The emulsion paint as claimed in one or more of claims 1 to 6, wherein n is an integer from 5 to 100.

8. The emulsion paint as claimed in one or more of claims 1 to 7, wherein m is an integer from 10 to 200.

9. The emulsion paint as claimed in one or more of claims 1 to 8, comprising 1 to 75 wt. % of (A).

10. The emulsion paint as claimed in one or more of claims 1 to 9, comprising 1 to 70 wt. % of (B).

11. The emulsion paint as claimed in one or more of claims 1 to 10, comprising 0.1 to 10 wt. % of (C).

12. The emulsion paint as claimed in one or more of claims 1 to 11, comprising 0.05 to 2 wt. % of (D).

13. The emulsion paint as claimed in one or more of claims 1 to 12, comprising 20 to 80 wt. % of water.

14. The use of compounds of the formula (I) 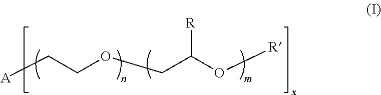
in which
A is a radical derived from a polyfunctional alcohol or alkanolamine having at least 3 active hydrogen atoms,
R is a methyl or ethyl radical,
R′ is a hydrogen atom or a methyl, ethyl, propyl, or butyl radical,
n is an integer from 1 to 250,
m is an integer from 1 to 500,
x is less than or equal to the number of active hydrogen atoms in the polyfunctional alcohol or alkanolamine from which A is derived,
and in which the polyoxyethylene and the polyoxyalkylene groups are arranged blockwise in the order indicated in the formula (I), as deaerating wetting agent and dispersant in emulsion paints comprising water and
(A) at least one polymer dispersion which comprises homopolymers or copolymers of olefinically unsaturated monomers,
(B) at least one inorganic white pigment or one inorganic filler,
(C) at least one organic chromatic pigment or carbon black pigment.
